(19) United States
(12) Patent Application Publication
(10) Pub. No.: US 2016/0212070 A1
(43) Pub. Date: Jul. 21, 2016

(54) PACKET PROCESSING APPARATUS UTILIZING INGRESS DROP QUEUE MANAGER CIRCUIT TO INSTRUCT BUFFER MANAGER CIRCUIT TO PERFORM CELL RELEASE OF INGRESS PACKET AND ASSOCIATED PACKET PROCESSING METHOD

(71) Applicant: MEDIATEK INC., Hsin-Chu (TW)

(72) Inventor: Chien-Hsiung Chang, Hsinchu County (TW)

(21) Appl. No.: 14/942,972

(22) Filed: Nov. 16, 2015

Related U.S. Application Data
(60) Provisional application No. 62/103,579, filed on Jan. 15, 2015.

(51) Int. Cl. H04L 12/861; H04L 12/18

(52) U.S. Cl. CPC H04L 49/90; H04L 12/18

(57) ABSTRACT

A packet processing apparatus includes a buffer manager (BM) circuit, an ingress drop queue manager (IDQM) circuit, and a queue manager (QM) circuit. The BM circuit maintains at least one multicast counter (MC) value for an ingress packet. The QM circuit maintains a plurality of egress queues for a plurality of egress ports, respectively. When the ingress packet is decided to be dropped for at least one egress port designated by the ingress packet, the QM circuit enqueues the ingress packet into the IDQM circuit without enqueuing the ingress packet into at least one egress queue of the at least one egress port, and the IDQM circuit refers to the ingress packet enqueued therein to request the BM circuit to perform cell release of the ingress packet.

### CROSS REFERENCE TO RELATED APPLICATIONS

This application claims the benefit of U.S. provisional application No. 62/103,579, filed on Jan. 15, 2015 and incorporated herein by reference.

### BACKGROUND

The disclosed embodiments of the invention relate to forwarding packets, and more particularly, to a packet processing apparatus utilizing an ingress drop queue manager circuit to instruct a buffer manager circuit to perform cell release of an ingress packet and associated method.

A network switch is a computer networking device that links different electronic devices. For example, the network switch receives an incoming packet generated from a source electronic device connected to it, and transmits an outgoing packet derived from the received packet only to one or more destination electronic devices for which the received packet is meant to be received. In general, the network switch has a packet buffer for buffering packet data of packets received from ingress ports, and forwards the packets stored in the packet buffer through egress ports. If the same packet is requested by a group of destination electronic devices connected to different egress ports of the network switch, a requested packet, also known as a multicast packet, is obtained in a single transmission from a source electronic device connected to one ingress port of the packet processing apparatus, and a multicast operation is performed by the network switch to deliver/broadcast copies of the requested packet (i.e., multicast packet) stored in the packet buffer to the group of destination electronic device. A multicast counter (or called as replication counter) is commonly used by the network switch to count the number of multicast or broadcast targets in a network.

In general, a packet is segmented into fixed-sized cells and stored into a packet buffer. In addition, a multicast counter (MC) value for a packet is calculated at the time a start cell of the packet is received, and is enqueued into an MC memory. In general, there is a one-to-one cell mapping between the packet buffer and the MC memory. The MC value indicates how many copies of the packet should be transmitted via egress ports. After an end cell of the multicast packet is received, the packet is enqueued into a single egress queue corresponding to a designated egress port if the packet is a unicast packet, and is enqueued into a plurality of egress queues corresponding to a plurality of designated egress ports if the packet is a multicast packet. For a unicast packet, the associated MC value is set by a positive integer equal to one. For a multicast packet, the associated MC value is set by a positive integer larger than one. However, it is possible that a received packet (particularly, a multicast packet) is not allowed to be forwarded to the designated egress port(s) due to certain factor(s). For example, a multicast packet stored in the packet buffer 106 may be decided to be dropped for at least one egress port designated by the multicast packet. When the received packet needs to be dropped, using a typical one-by-one release mechanism at the egress side to reduce an MC value of the received packet is unable to efficiently release used cells of the received packet in the MC memory. Hence, there is a need for an innovative cell release design which is capable of quickly releasing used cells of a received packet in the MC memory.

### SUMMARY

In accordance with exemplary embodiments of the invention, a packet processing apparatus utilizing an ingress drop queue manager circuit to instruct a buffer manager circuit to perform cell release of an ingress packet and an associated packet processing method are proposed to solve the above-mentioned problem.

According to a first aspect of the invention, an exemplary packet processing apparatus is disclosed. The exemplary packet processing apparatus includes a buffer manager (BM) circuit, an ingress drop queue manager (IDQM) circuit, and a queue manager (QM) circuit. The BM circuit is arranged to maintain at least one multicast counter (MC) value for an ingress packet. The QM circuit is arranged to maintain a plurality of egress queues for a plurality of egress ports, respectively. When the ingress packet is decided to be dropped for at least one egress port designated by the ingress packet, the QM circuit is arranged to enqueue the ingress packet into the IDQM circuit without enqueuing the ingress packet into at least one egress queue of the at least one egress port, and the IDQM circuit is arranged to refer to the ingress packet enqueued therein to request the BM circuit to perform cell release of the ingress packet.

According to a second aspect of the invention, an exemplary packet processing method is disclosed. The exemplary packet processing method includes: maintaining at least one multicast counter (MC) value for an ingress packet; maintaining a plurality of egress queues for a plurality of egress ports, respectively; when the ingress packet is decided to be dropped for at least one egress port designated by the ingress packet, not enqueuing the ingress packet into at least one egress queue of the at least one egress port, and enqueuing the ingress packet into an ingress drop queue; and referring to information of the ingress packet enqueued in the ingress drop queue to control cell release of the ingress packet.

According to a third aspect of the invention, an exemplary packet processing apparatus is disclosed. The exemplary packet processing apparatus includes a buffer manager (BM) circuit. The BM circuit includes a first multicast counter (MC) memory device, a second MC memory device, and a controller. The first MC memory device is arranged to store at least one MC value for a received packet. The second MC memory device is arranged to store at least one cell release threshold value for the received packet. The controller is arranged to compare the at least one MC value in the first MC memory device with the at least one cell release threshold value in the second MC memory device to control cell release of the received packet.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a packet processing apparatus according to an embodiment of the invention.

FIG. 2 is a diagram illustrating an example of a packet buffer, a multicast counter memory and a linked list memory after packet data of an ingress packet is received by a buffer manager circuit shown in FIG. 1.

FIG. 3 is a diagram illustrating an example of egress queues when received packets are enqueued for transmission through egress port controllers.

FIG. 4 is a diagram illustrating a first data structure employed by an ingress drop queue according to an embodiment of the invention.

FIG. 5 is a diagram illustrating a first configuration of an interface between the queue manager circuit and the ingress drop manager circuit and an interface between the ingress drop queue circuit and the buffer manager circuit according to an embodiment of the invention.

FIG. 6 is a flowchart illustrating a packet enqueue flow of an ingress packet decided to be dropped for at least one egress port designated by the ingress packet according to an embodiment of the invention.

FIG. 7 is a flowchart illustrating a packet release flow of an ingress packet decided to be dropped for at least one egress port designated by the ingress packet according to an embodiment of the invention.

FIG. 8 is a diagram illustrating a modified linked list structure for the linked list memory according to an embodiment of the invention.

FIG. 9 is a diagram illustrating a modified FIFO structure for the ingress drop queue according to an embodiment of the invention.

FIG. 10 is a diagram illustrating a second configuration of an interface between the queue manager circuit and the ingress drop queue manager circuit and an interface between the ingress drop queue manager circuit and the buffer manager circuit according to an embodiment of the invention.

FIG. 11 is a flowchart illustrating another packet enqueue flow of an ingress packet decided to be dropped for at least one egress port designated by the ingress packet according to an embodiment of the invention.

FIG. 12 is a flowchart illustrating another packet release flow of an ingress packet decided to be dropped for at least one egress port designated by the ingress packet according to an embodiment of the invention.

FIG. 13 is a diagram illustrating a configuration of an interface between one egress port controller and the queue manager circuit according to an embodiment of the invention.

FIG. 14 is a diagram illustrating a multicast counter enqueue operation applied to a multicast counter memory implemented using multiple memory devices according to an embodiment of the invention.

FIG. 15 is a diagram illustrating a first multicast counter dequeue operation applied to a multicast counter memory implemented using multiple memory devices according to an embodiment of the invention.

FIG. 16 is a diagram illustrating a second multicast counter dequeue operation applied to a multicast counter memory implemented using multiple memory devices according to an embodiment of the invention.

FIG. 17 is a diagram illustrating a third multicast counter dequeue operation applied to a multicast counter memory implemented using multiple memory devices according to an embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

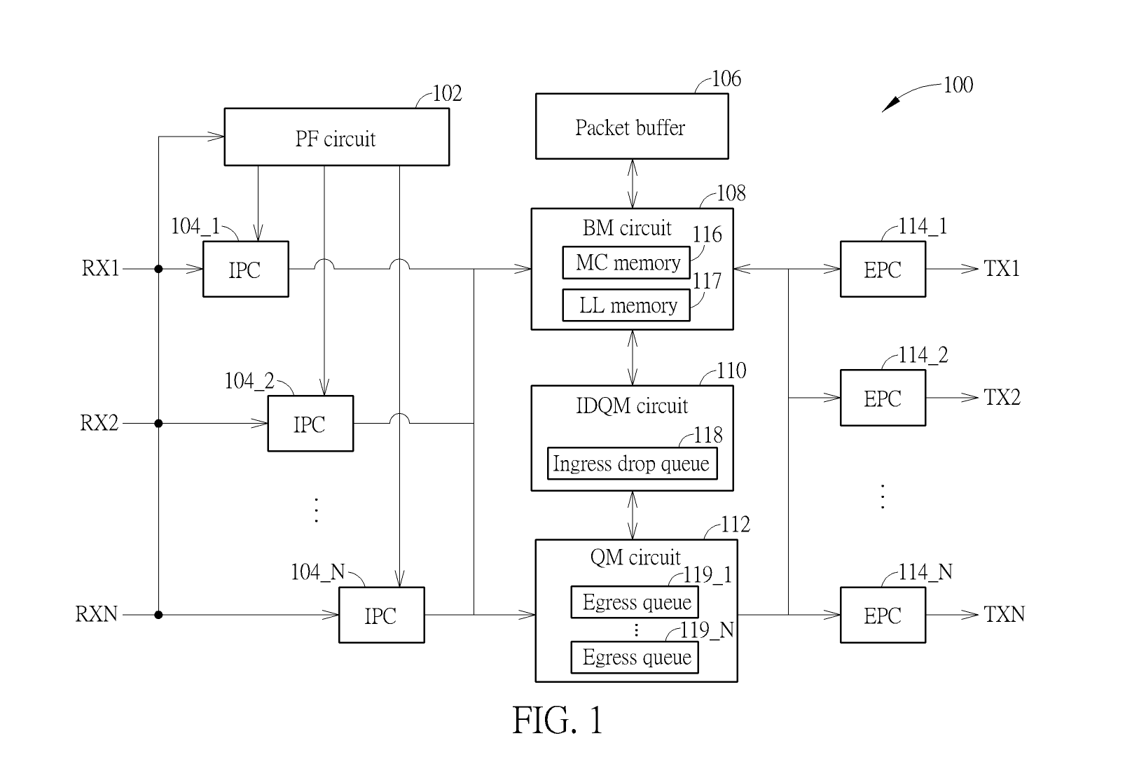

FIG. 1 is a block diagram illustrating a packet processing apparatus according to an embodiment of the invention. For example, the packet processing apparatus 100 maybe a network switch. As shown in FIG. 1, the packet processing apparatus 100 includes a packet forwarding (PF) circuit 102, a plurality of ingress port controllers (IPCs) 104_1-104_N, a packet buffer 106, a buffer manager (BM) circuit 108, an ingress drop queue manager (IDQM) circuit 110, a queue manager (QM) circuit 112, and a plurality of egress port controllers (EPCs) 114_1-114_N. The IPCs 104_1-104_N are coupled to a plurality of ingress ports RX1-RXN, respectively; and the EPCs 114_1-114_N are coupled to a plurality of egress ports TX1-TXN, respectively. It should be noted that the number of ingress ports may be equal to or different from the number of egress ports, depending upon actual design considerations.

The PF circuit 102 is configured to have a packet forwarding table. Hence, the PF circuit 102 refers to the packet forwarding table and the packet data of an ingress packet received from one ingress port (e.g., RX1) to decide a forwarding result. Next, based on the forwarding result generated from the PF circuit 102, a corresponding IPC (e.g., 104_1) sends the packet data of the ingress packet to the BM circuit 108 and enqueues the ingress packet into the QM circuit 112.

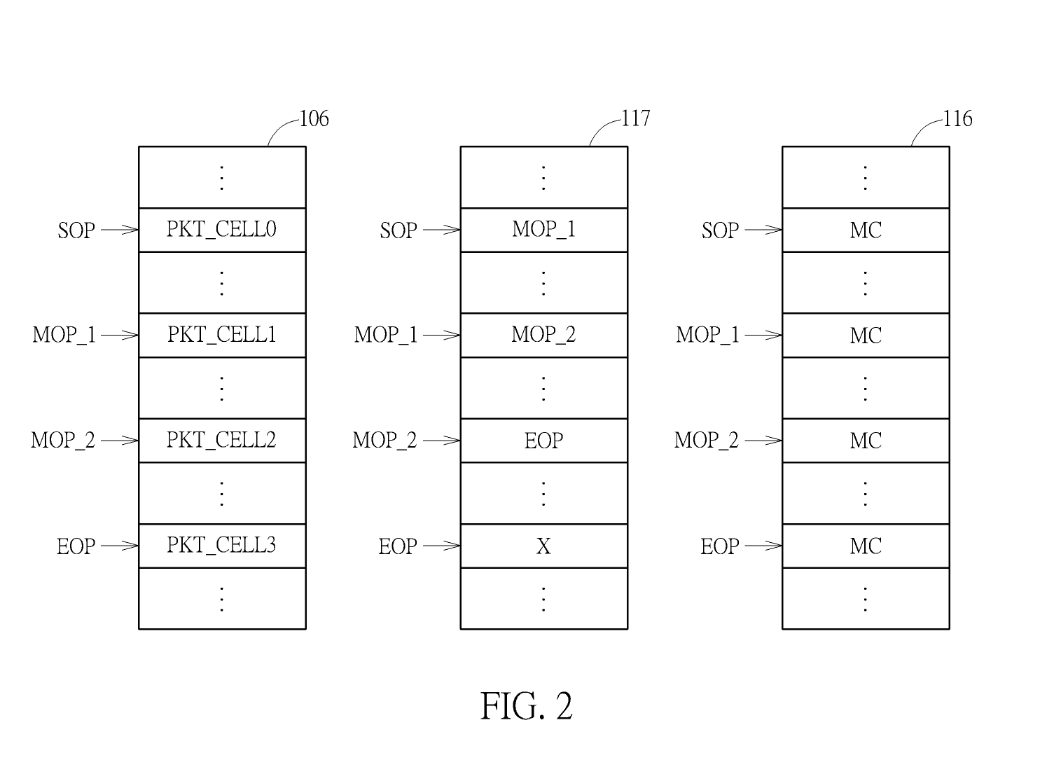

The BM circuit 108 is arranged to manage the buffer usage of the packet buffer 106, and is configured to have an MC memory 116 and a linked list (LL) memory 117. FIG. 2 is a diagram illustrating an example of packet buffer 106, MC memory 116 and LL memory 117 after packet data of an ingress packet is received by the BM circuit 108. The packet buffer 106 is used to buffer the packet data of the received packets. However, free storage spaces in the packet buffer 106 may be distributed at discontinuous memory locations. Hence, when the packet processing apparatus (e.g., network switch) 100 receives an ingress packet (e.g., multicast packet) from one of the ingress ports RX1-RXN, the BM circuit 108 may store cells of the ingress packet (i.e., multicast packet) into discontinuous memory locations of the packet buffer 106. Suppose that the ingress packet (i.e., multicast packet) is segmented into four cells PKT_CELL0-PKT_CELL3, where PKT_CELL0 is a start of packet (SOP) cell, PKT_CELL3 is an end of packet (EOP) cell, and PKT_CELL1 and PKT_CELL2 are middle of packet (MOP) cells. The first cell PKT_CELL0 of the ingress packet is stored at a first memory address (i.e., an SOP cell address, denoted by “SOP”), the second cell PKT_CELL1 of the ingress packet is stored at a second memory address (i.e., one MOP cell address, denoted by “MOP_1”), the third cell PKT_CELL2 of the ingress packet is stored at a third memory address (i.e., another MOP cell address, denoted by “MOP_2”), and the last cell PKT_CELL3 of the ingress packet is stored at a fourth memory address (i.e., an EOP cell address, denoted by “EOP”).

To manage packet cell data stored in the packet buffer 118, a linked list is created in the LL memory 117. In this example, the head node of the linked list for the stored ingress packet is at the memory address being the SOP cell address, and the next cell address recorded in the head node is MOP_1, meaning that the next node in the linked list is at a memory address MOP_1. The second node of the linked list for the stored ingress packet is at the memory address MOP_1, and the next cell address recorded in the second node is MOP_2, meaning that the next node in the linked list is at a memory address MOP_2. The third node of the linked list for the stored ingress packet is at the memory address MOP_2, and the next cell address recorded in the third node is EOP, meaning that the next node in the linked list is at a memory address EOP. The tail node of the linked list for the stored ingress packet is at the memory address EOP, and the next cell address recorded in the tail node is “don't care” (denoted by X). The packet cells stored in the packet buffer 106 can be easily retrieved by traversing the linked list. For example, a transmitter (e.g., EPC 114_1) can use the SOP cell address to get the SOP cell stored in the packet buffer 106, and can further use the SOP cell address to read the head node of the linked list to obtain the next cell address MOP_1. The transmitter (e.g., EPC 114_1) can use the MOP cell address (e.g., MOP_1) to get the first MOP cell stored in the packet buffer 106, and can further use the MOP cell address (e.g., MOP_1) to read the second node of the linked list to obtain the next cell address MOP_2. The transmitter (e.g., EPC 114_1) can use the MOP cell address (e.g., MOP_2) to get the second MOP cell stored in the packet buffer 106, and can further use the MOP cell address (e.g., MOP_2) to read the third node of the linked list to obtain the next cell address EOP. The transmitter (e.g., EPC 114_1) can use the EOP cell address to get the EOP cell stored in the packet buffer 106. After the EOP cell is transmitted, the packet transmission is finished.

Based on the forwarding result determined based on data in the SOP cell of the ingress packet, the BM circuit 108 knows the number of egress ports designated by the ingress packet (i.e., the number of copies of the ingress packet that should be transmitted via different egress ports). Hence, at least one initial MC value (denoted by “MC”) for the ingress packet is enqueued by a write operation. There are two types of MC enqueue and dequeue, including cell-based MC enqueue and dequeue and packet-based MC enqueue and dequeue. In a case where a cell-based MC enqueue and dequeue method is employed, the same initial MC value is stored into every cell locations associated with the stored ingress packets. As shown in FIG. 2, the same initial MC value is stored at cell addresses SOP, MOP_1, MOP_2 and EOP. When a copy of one of the cells PKT_CELL0-PKT_CELL3 is transmitted via one designated egress port successfully, an MC value associated with this cell is dequeued by a read-modify-write operation, thus resulting in a reduced value (MC−1) stored in the MC memory 116. When an MC value associated with a specific packet cell is reduced to zero, the BM circuit 108 releases the used cell in the MC memory, such that one free cell is available and can be used now.

In another case where a packet-based MC enqueue and dequeue method is employed, the initial MC value is stored into only one of the cell locations associated with the stored ingress packet. For example, the initial MC value is stored in one of cell addresses SOP, MOP_1, MOP_2 and EOP, depending upon an actual algorithm design. When a copy of the ingress packet, including cells PKT_CELL0-PKT_CELL3, is transmitted via one designated egress port successfully, the MC value is dequeued via a read-modify-write operation, thus resulting in a reduced value (MC−1) stored in the MC memory 116. When the MC value associated with the stored ingress packet cell is reduced to zero, the BM circuit 108 releases all used cells in the MC memory such that free cells are available and can be used now.

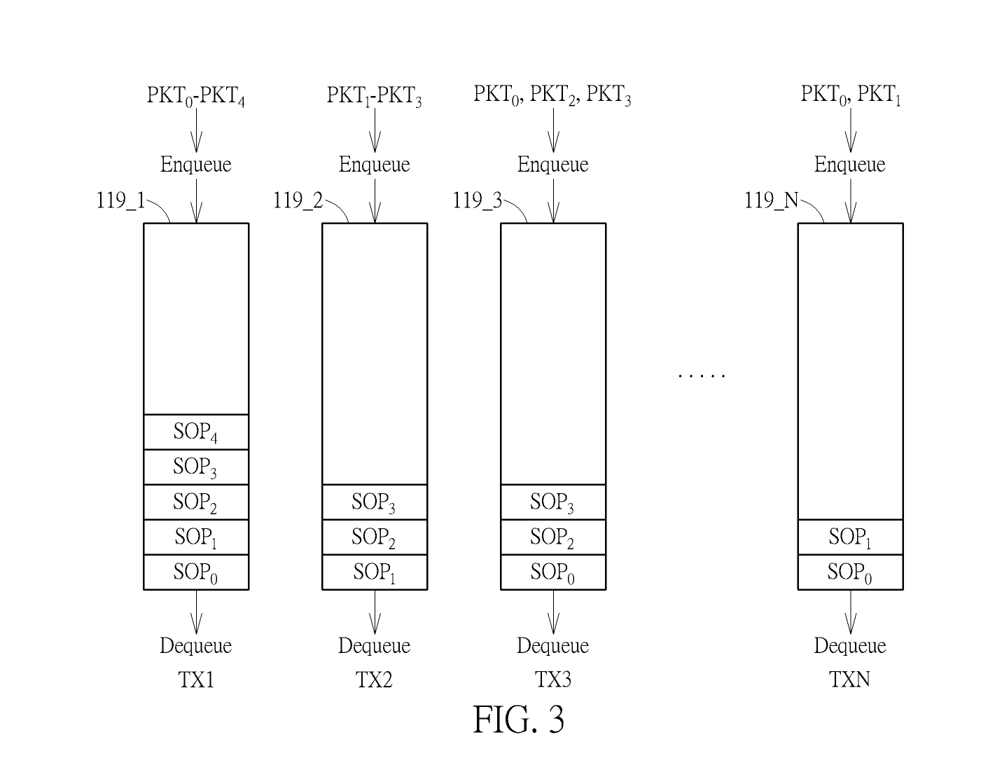

The QM circuit 112 is arranged to maintain a plurality of egress queues 119_1-119_N for a plurality of egress ports 114_1-114_N, respectively. When the PF circuit 102 decides that a packet received from a specific ingress port should be forwarded to specific egress ports, an IPC associated the specific ingress port enqueues the packet into egress queues associated with the specific egress ports. FIG. 3 is a diagram illustrating an example of egress queues 119_1-119_N when received packets are enqueued for transmission through EPCs 114_1-114_N. When the PF circuit 102 decides that a first packet PKT₀ received from one ingress port should be forwarded to egress ports TX₁, TX₃, TX_{N}, the packet PKT₀ is enqueued into the egress queues 119_1, 119_3, 119_N by storing an associated SOP cell address SOP₀ into the egress queues 119_1, 119_3, 119_N. When the PF circuit 102 decides that a second packet PKT₁ received from one ingress port should be forwarded to egress ports TX₁, TX_{N}, the packet PKT₁ is enqueued into the egress queues 119_1, 119_N by storing an associated SOP cell address SOP₁ into the egress queues 119_1, 119_N. When the PF circuit 102 decides that a third packet PKT₂ received from one ingress port should be forwarded to egress ports TX₁, TX₂, TX₃, the packet PKT₂ is enqueued into the egress queues 119_1, 119_2, 119_3 by storing an associated SOP cell address SOP₃ into the egress queues 119_1, 119_2, 119_3. When the PF circuit 102 decides that a fourth packet PKT₃ received from one ingress port should be forwarded to egress ports TX₁, TX₂, TX₃, the packet PKT₃ is enqueued into the egress queues 119_1, 119_2, 119_3 by storing an associated SOP cell address SOP₃ into the egress queues 119_1, 119_2, 119_3. When the PF circuit 102 decides that a fifth packet PKT₄ received from one ingress port should be forwarded to egress port TX₁, the packet PKT₄ is enqueued into the egress queue 119_1 by storing an associated SOP cell address SOP₄ into the egress queue 119_1.

Each of the EPCs 114_1-114_N is arranged to sequentially dequeue packets from a corresponding egress queue, and utilize output packet information obtained from the QM circuit 112 to request the BM circuit 108 for packet data of the dequeued packets and then transmit the packet data of the dequeued packets via a corresponding egress port. For example, the EPC 114_1 dequeues the first packet PKT₀ from the egress queue 119_1 to obtain the SOP cell address SOP₀ of the first packet PKT₀, and sends the SOP cell address SOP₀ to the BM circuit 108. Next, the BM circuit 108 refers to the SOP cell address SOP₀ to traverse a linked list of the first packet PKT₀ that is recorded in the LL memory 117 for reading all cells of the first packet PKT₀ from the packet buffer 106, and provides the packet data of the first packet PKT₀ to the EPC 114_1. It should be noted that the MC memory 116 will be updated after a copy of the first packet PKT₀ is successfully transmitted by the EPC 114_1 via the egress port TX1.

As mentioned above, an initial MC value for an ingress packet is calculated based on data in a start cell of the received ingress packet, and is enqueued into the MC memory 116. However, after some or all cells are received, the IPC and/or the QM circuit may find that the received ingress packet is not allowed to be forwarded to at least a portion (e.g., part or all) of the designated egress ports due to certain factor (s). If the one-by-one release mechanism at the egress side is employed for releasing used cells of a received packet (which is decided to be dropped) to the BM circuit 108, a transmitter at the egress side gets the received packet but does not transmit the received packet, and performs an MC dequeue operation upon the MC memory 116 to reduce the MC value by one (i.e., MC=MC−1). This is a simple way to handle the cell release of the received packet which is decided to be dropped. However, the transmitter performance is degraded because the received packet is received by a transmitter but not transmitted from the transmitter. In addition, the one-by-one release mechanism at the egress side applies a fixed MC decrement value (e.g., 1) to the MC value each time the received packet decided to be dropped is received by a transmitter but not transmitted from the transmitter. Hence, due to the inherent characteristics of the one-by-one release mechanism at the egress side, the MC value is gradually reduced to a zero value. The invention therefore proposes using the IDQM circuit 110 to deal with cell release of an ingress packet decided to be dropped for quickly releasing used cells of the ingress packet to the BM circuit 108. Since cell release of the ingress packet decided to be dropped is handled by the IDQM circuit 110 rather than transmitters at the egress side (i.e., EPCs 114_1-114_N), the transmitter performance is not degraded by cell release of the ingress packet decided to be dropped. Further details of the proposed IDQM circuit 110 are described as below.

As shown in FIG. 1, the IDQM circuit 110 has an ingress drop queue 118. When an ingress packet is decided to be forwarded to all egress ports designated by the ingress packet, the QM circuit 112 is arranged to enqueue the ingress packet into egress queues corresponding to the designated egress ports for packet transmission. However, when the ingress packet is decided to be dropped for at least one egress port designated by the ingress packet, the QM circuit 112 is arranged to enqueue the ingress packet into the ingress drop queue 118 of the IDQM circuit 110 without enqueuing the ingress packet to the at least one egress queue corresponding to the at least one egress port, and the IDQM circuit 110 is arranged to refer to the ingress packet enqueued therein to control cell release of the ingress packet in the BM circuit 108.

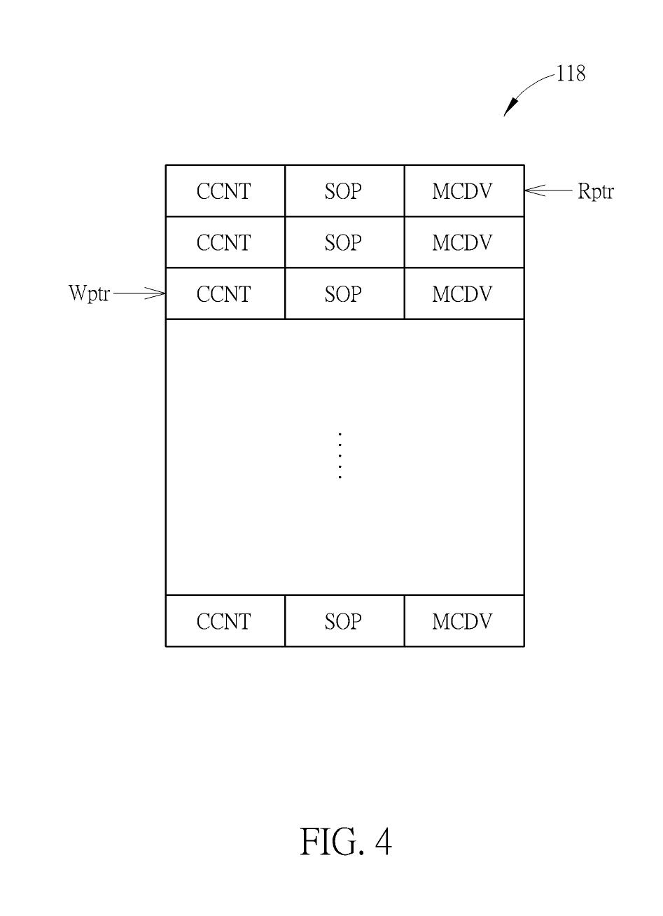

FIG. 4 is a diagram illustrating a first data structure employed by the ingress drop queue 118 according to an embodiment of the invention. A first-in first-out (FIFO) structure is employed by the ingress drop queue 118. The QM circuit 112 requests the IDQM circuit 110 for ingress packet processing. The IDQM circuit 110 enqueues an ingress packet (which is decided to be dropped for at least one egress port designated by the ingress packet) into the ingress drop queue 118 by storing packet information of the ingress packet into one entry of the ingress drop queue 118 using the exemplary FIFO structure shown in FIG. 4, and then requests the BM circuit 108 to release used cells of the ingress packet. Entries of the ingress drop queue 118 are accessed by a FIFO write pointer Wptr and a FIFO read pointer Rptr. The packet information of the ingress packet stored in one entry of the ingress drop queue 118 includes a used cell count (denoted by “CCNT”) of the ingress packet stored in the packet buffer 106, an SOP cell address (denoted by “SOP”) of the ingress packet stored in the packet buffer 106, and an MC decrement value (denoted by “MCDV”) for the ingress packet. The IDQM circuit 110 controls cell release of the ingress packet (which is decided to be dropped for at least one egress port designated by the ingress packet) in the BM circuit 108.

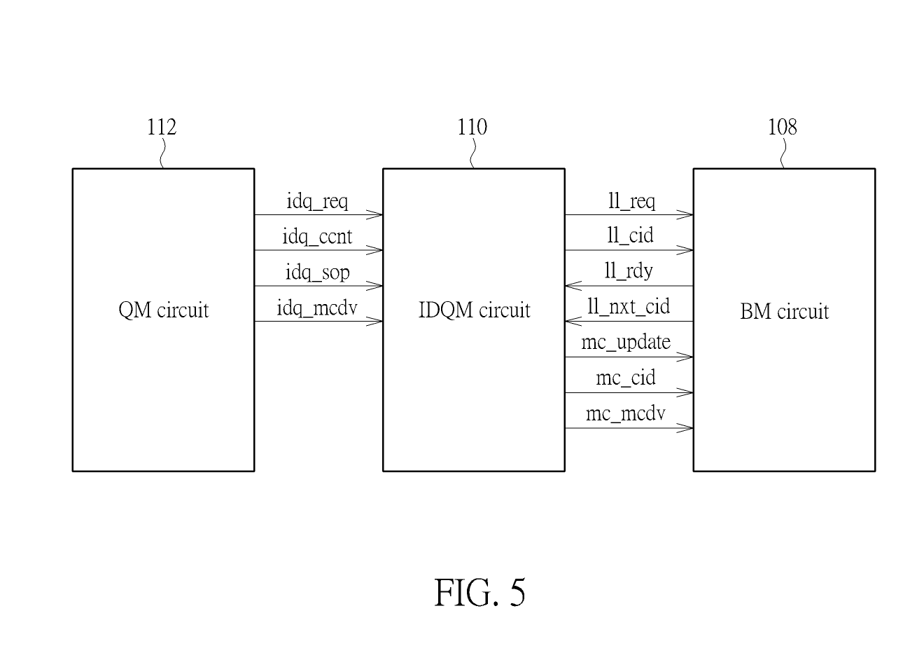

FIG. 5 is a diagram illustrating a first configuration of an interface between the QM circuit 112 and the IDQM circuit 110 and an interface between the IDQM circuit 110 and the BM circuit 108 according to an embodiment of the invention. When an ingress packet is decided to be dropped for at least one egress port designated by the ingress packet, the QM circuit 112 outputs packet information of the ingress packet to the IDQM circuit 110 for enqueuing the ingress packet into the IDQM circuit 110. In this embodiment, it is assumed that the IDQM circuit 110 can absorb all ingress packet enqueue requests from the QM circuit 112. As shown in FIG. 5, the QM circuit 112 generates signals idq_req, idq_ccnt, idq_sop, idq_mcdv to the IDQM circuit 110 for enqueuing an ingress packet to be dropped into the IDQM circuit 110, where the signal idq_req is a request for enqueuing the ingress packet to be dropped, the signal idq_ccnt carries a used cell count of the ingress packet to be dropped, the signal idq_sop carries an SOP cell address of the ingress packet to be dropped, and the signal idq_mcdv carries an MC decrement value of the ingress packet to be dropped.

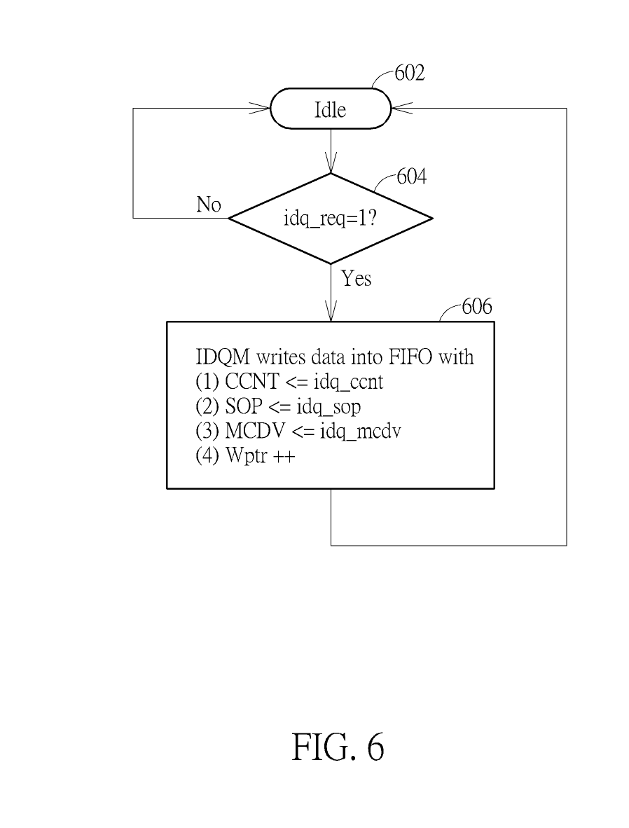

FIG. 6 is a flowchart illustrating a packet enqueue flow of an ingress packet decided to be dropped for at least one egress port designated by the ingress packet according to an embodiment of the invention. Provided that the result is substantially the same, the steps are not required to be executed in the exact order shown in FIG. 6. In addition, one or more steps may be added to or removed from the packet enqueue flow shown in FIG. 6. The packet enqueue flow is performed by the IDQM circuit 110. In step 604, the IDQM circuit 110 checks if idq_req=1. If idq_req=0, it means that there is no request for enqueuing an ingress packet to be dropped. Hence, the IDQM circuit 110 enters an idle state (Step 602). In this embodiment, the IDQM circuit 110 may periodically check if idq_req=1. If idq_req=1, it means that there is a request for enqueuing an ingress packet to be dropped. Hence, the flow proceeds with step 606. The IDQM circuit 110 enqueues the ingress packet to be dropped into the ingress drop queue (e.g., FIFO buffer) 118 by storing the associated packet information into an entry pointed to by the FIFO write pointer Wptr, where the packet information (CCNT, SOP, MCDV) is set by (idq_ccnt, idq_sop, idq_mcdv). After the ingress packet to be dropped is enqueued, the IDQM circuit 110 increases the FIFO write pointer Wptr to point to a next entry of the ingress drop queue (e.g., FIFO buffer) 118, and then enters the idle state.

As shown in FIG. 5, the IDQM circuit 110 generates signals ll_req and ll_cid to the BM circuit 108, and the BM circuit 108 responds with signals ll_rdy and ll_nxt_cid. In this embodiment, it is assumed that the cell-based MC enqueue and dequeue method is employed by the BM circuit 108. The signal ll_req is a request for getting a next cell address in a linked list, and the signal ll_cid is a current cell address in the linked list. An initial value of the current cell address in the linked list is the SOP cell address. The signal ll_rdy is asserted by the BM circuit 108 when the next cell address requested by the IDQM circuit 110 is ready. The signal ll_nxt_cid generated by the BM circuit 108 carries the next cell address requested by the IDQM circuit 110. In addition, the IDQM circuit 110 also generates signals mc_update, mc_cid, mc_mcdv to the BM circuit 108, where the signal mc_update is a request for updating an MC value, the signal mc_cid carries a cell address for MC update, and the signal mc_mcdv carries an MCDV value for MC update.

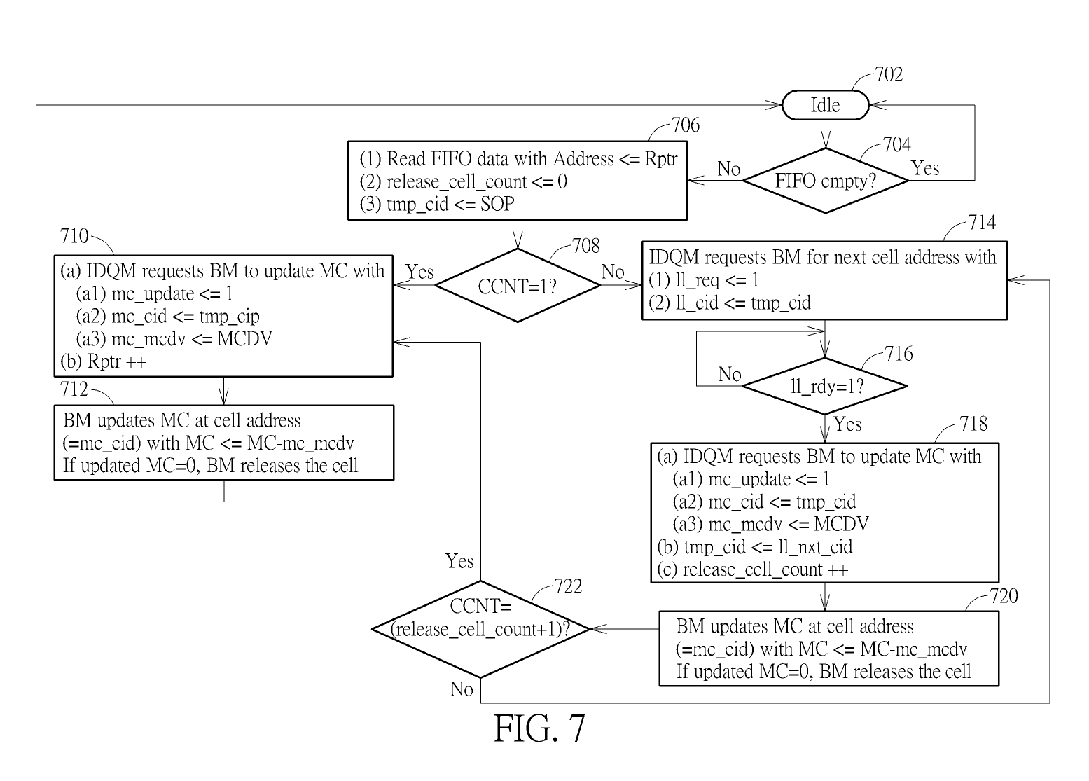

FIG. 7 is a flowchart illustrating a packet release flow of an ingress packet decided to be dropped for at least one egress port designated by the ingress packet according to an embodiment of the invention. Provided that the result is substantially the same, the steps are not required to be executed in the exact order shown in FIG. 7. In addition, one or more steps may be added to or removed from the packet release flow shown in FIG. 7. The packet release flow is performed by the IDQM circuit 110 and the BM circuit 108 in FIG. 5. In step 704, the IDQM circuit 110 checks if the ingress drop queue (e.g., FIFO buffer) 118 is empty. If the ingress drop queue (e.g., FIFO buffer) 118 is empty, it means that there is no ingress packet to be dropped. Hence, the IDQM circuit 110 enters an idle state (Step 702). In this embodiment, the IDQM circuit 110 may periodically check if the ingress drop queue (e.g., FIFO buffer) 118 is empty. If the ingress drop queue (e.g., FIFO buffer) 118 is not empty, the packet release flow proceeds with step 706. In step 706, the IDQM circuit 110 reads packet information recorded in an entry pointed to by the FIFO read pointer Rptr, sets a variable release_cell_count by an initial value (e.g., 0), and sets another variable tmp_cid by an initial value, e.g., an SOP cell address read from the entry pointed to by the FIFO read pointer Rptr. The variable release_cell_count records the number of released cells of the ingress packet to be dropped, and the variable tmp_cid records the current cell address for MC update.

In step 708, the IDQM circuit 110 checks if the CCNT value obtained in step 706 is equal to one. If CCNT=1, it means that the packet length of the ingress packet to be dropped is equal to or smaller than a one-cell size. Hence, there is no need to traverse a linked list of such a single-cell packet. The packet release flow proceeds with step 710. In step 710, the IDQM circuit 110 asserts the signal mc_update, sets the signal mc_cid by the variable tmp_cid, and sets the signal mc_mcdv by the MCDV value obtained in step 706. After the signals mc_update, mc_cid, mc_mcdv are generated from the IDQM circuit 110 to the BM circuit 108, the IDQM circuit 110 increases the FIFO read pointer Rptr to point to a next entry of the ingress drop queue (e.g., FIFO buffer) 118. In step 712, the BM circuit 108 updates an MC value at a cell address indicated by the signal mc_cid according to the MCDV value indicated by the signal mc_mcdv. In this embodiment, an updated MC value is derived from subtracting the MCDV value from the current MC value. If the updated MC value is equal to zero, the BM circuit 108 releases the cell at the cell address indicated by the signal mc_cid. Next, the packet release flow proceeds with step 702.

If step 708 finds that CCNT≠1, it is determined that the packet length of the ingress packet to be dropped is larger than a one-cell size. Hence, a linked list of such a multi-cell packet should be traversed to find every next cell address. The packet release flow therefore proceeds with step 714. In step 714, the IDQM circuit 110 asserts the signal ll_req and sets the signal ll_cid by the variable tmp_cid. In step 716, the IDQM circuit 110 checks if the signal ll_rdy is asserted by the BM circuit 108. The flow does not proceed with step 718 until signal ll_rdy is asserted by the BM circuit 108. After the signal ll_rdy is asserted by the BM circuit 108, the IDQM circuit 110 gets the signal ll_nxt_cid from the BM circuit 108 to known the next cell address. In step 718, the IDQM circuit 110 asserts the signal mc_update, sets the signal mc_cid by the variable tmp_cid, and sets the signal mc_mcdv by the MCDV value obtained in step 706. After the signals mc_update, mc_cid, mc_mcdv are generated from the IDQM circuit 110 to the BM circuit 108, the IDQM circuit 110 updates the variable tmp_cid by the next cell address indicated by the signal ll_nxt_cid given by the BM circuit 108, and increases the variable release_cell_count. In step 720, the BM circuit 108 updates an MC value at a cell address indicated by the signal mc_cid according to the MCDV value indicated by the signal mc_mcdv. In this embodiment, an updated MC value is derived from subtracting the MCDV value from the current MC value. If the updated MC value is equal to zero, the BM circuit 108 releases the cell at the cell address indicated by the signal mc_cid.

Since the ingress packet to be dropped is a multi-cell packet, the packet release flow proceeds with step 722 to check if the CCNT value obtained in step 706 is equal to release_cell_count+1. If CCNT=release_cell_count+1, it means that the next cell is the last cell of the ingress packet to be dropped. Hence, there is no need to get the next cell address from the BM circuit 108, and the packet release flow proceeds with step 710. Steps 710 and 712 are executed for releasing the last cell of the ingress packet to be dropped. However, if CCNT≠release_cell_count+1, it means that the next cell is not the last cell of the ingress packet to be dropped. Hence, the next cell address needs to be obtained from the BM circuit 108, and the packet release flow proceeds with step 714. Steps 714, 716, 718 and 720 are executed for releasing the current cell of the ingress packet to be dropped.

As mentioned above, the CCNT value is used to indicate whether the ingress packet to be dropped is a single-cell packet (Step 708), and is compared with the variable release_cell_count maintained by the IDQM circuit 110 to determine if the next cell is the last cell of the ingress packet to be dropped (Step 722). Hence, the CCNT value is recorded in an entry of the ingress drop queue (e.g., FIFO buffer) 118 that stores packet information of the ingress packet to be dropped. In general, the bit length of each CCNT value stored in one queue entry depends on the maximum number of cells of one packet. Hence, recording CCNT values in the ingress drop queue (e.g., FIFO buffer) 118 will increase the memory size requirement of the ingress drop queue (e.g., FIFO buffer) 118. To relax the memory size requirement of the ingress drop queue (e.g., FIFO buffer) 118, the invention proposes a modified linked list structure for the linked list memory 117 and a modified FIFO structure for the ingress drop queue 118.

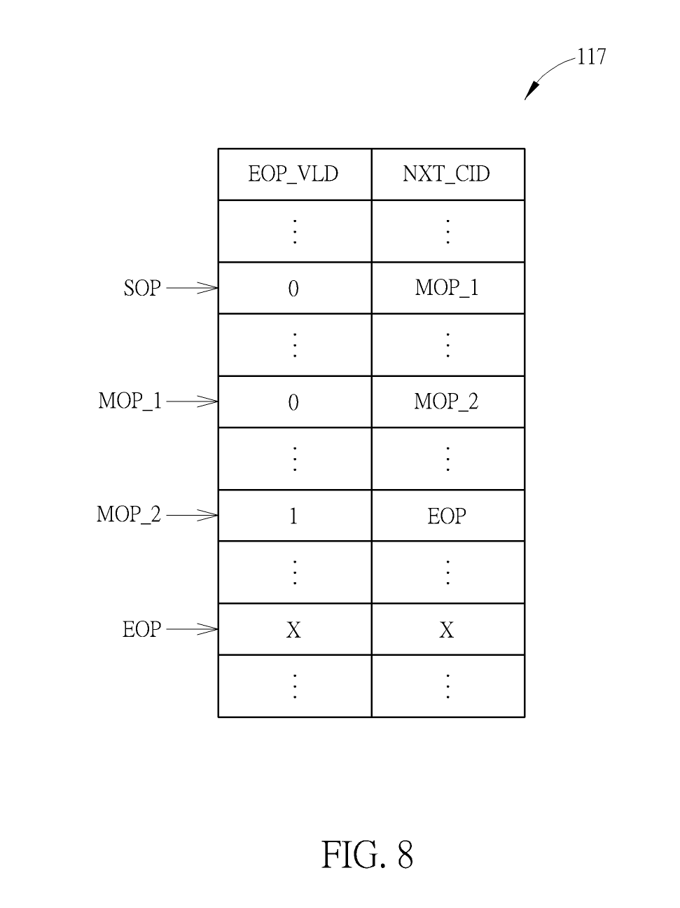

FIG. 8 is a diagram illustrating a modified linked list structure for the linked list memory 117 according to an embodiment of the invention. Each node of a linked list includes an EOP_VLD field and a NXT_CID field, where the NXT_CID field records the next cell address, and the one-bit EOP_VLD field records a one-bit EOP valid flag used to indicate if the next cell is an EOP cell. In this example, concerning the head node of the linked list, since the next node in the linked list is not at the EOP cell address, the EOP valid flag is set by “0”. Concerning the second node of the linked list, since the next node in the linked list is not the EOP cell address, the EOP valid flag is set by “0”. Concerning the third node of the linked list for the stored ingress packet, since the next node in the linked list is at the EOP cell address, the EOP valid flag is set by “1”. Concerning the tail node of the linked list for the stored ingress packet, each of the next cell address and the EOP valid flag is set by “don't care” (denoted by “X”).

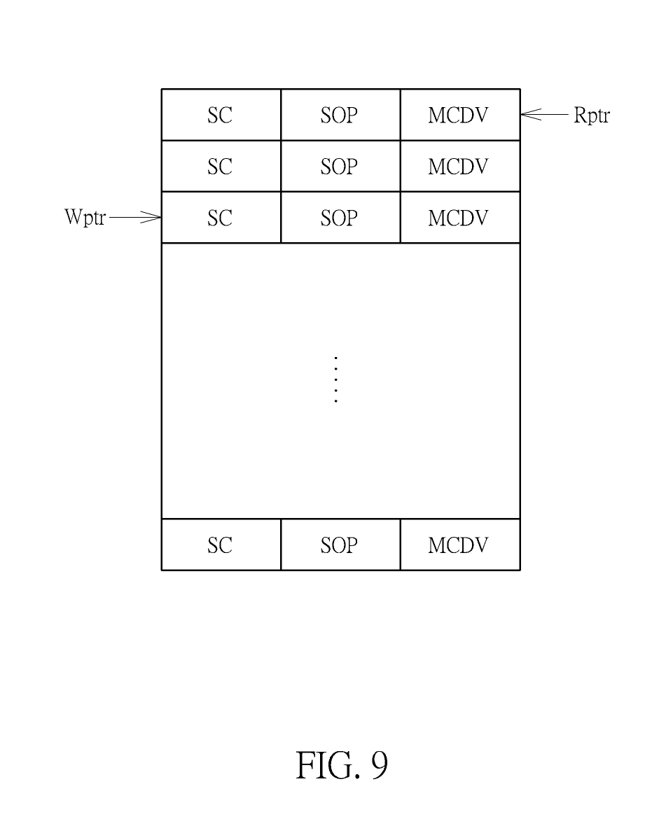

FIG. 9 is a diagram illustrating a modified FIFO structure for the ingress drop queue 118 according to an embodiment of the invention. The modified FIFO structure is derived from replacing each used cell count CCNT recorded in the FIFO structure shown in FIG. 4 with a one-bit single cell packet flag SC. The single cell packet flag SC indicates whether a packet length of the ingress packet is not larger than a one-cell size. If SC=1, it indicates that the associated ingress packet to be dropped is a single-cell packet. If SC=0, it indicates that the associated ingress packet to be dropped is a multi-cell packet.

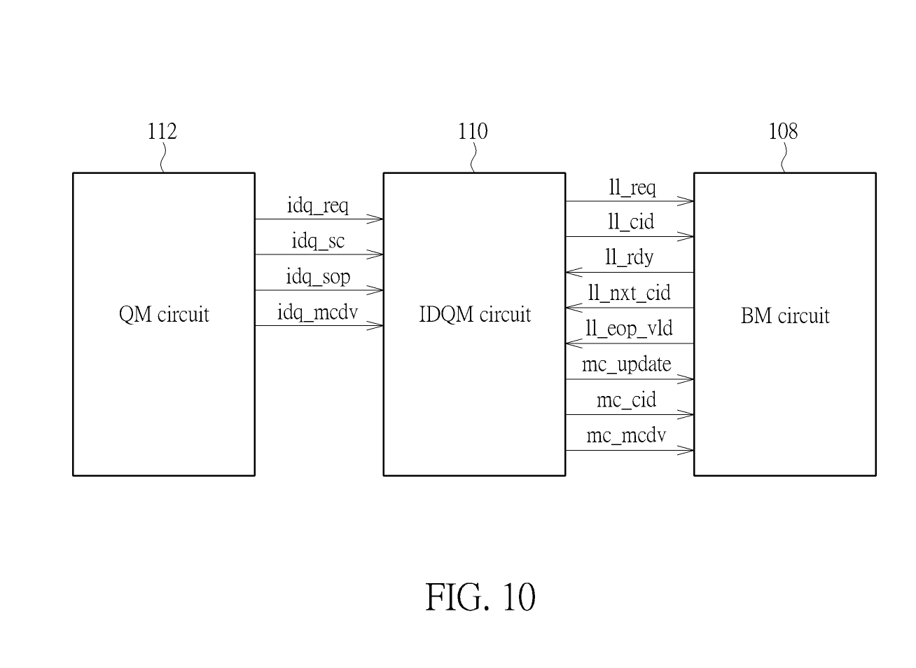

In a case where the modified linked list structure is employed by the linked list memory 117 and the modified FIFO structure is employed by the ingress drop queue 118, the interface between the IDQM circuit 110 and the BM circuit 108 is modified correspondingly. FIG. 10 is a diagram illustrating a second configuration of an interface between the QM circuit 112 and the IDQM circuit 110 and an interface between the IDQM circuit 110 and the BM circuit 108 according to an embodiment of the invention. In this embodiment, the QM circuit 112 generates signals idq_req, idq_sc, idq_sop, idq_mcdv, where the signal idq_sc carries a single cell packet flag SC of the ingress packet to be dropped. As shown in FIG. 10, the IDQM circuit 110 generates signals ll_req and ll_cid to the BM circuit 108, and the BM circuit 108 responds with signals ll_rdy, ll_nxt_cid and ll_eop_vld. In this embodiment, it is also assumed that the cell-based MC enqueue and dequeue scheme is employed by the BM circuit 108. The signal ll_rdy is asserted by the BM circuit 108 when the next cell address and the EOP valid flag requested by the IDQM circuit 110 are ready.

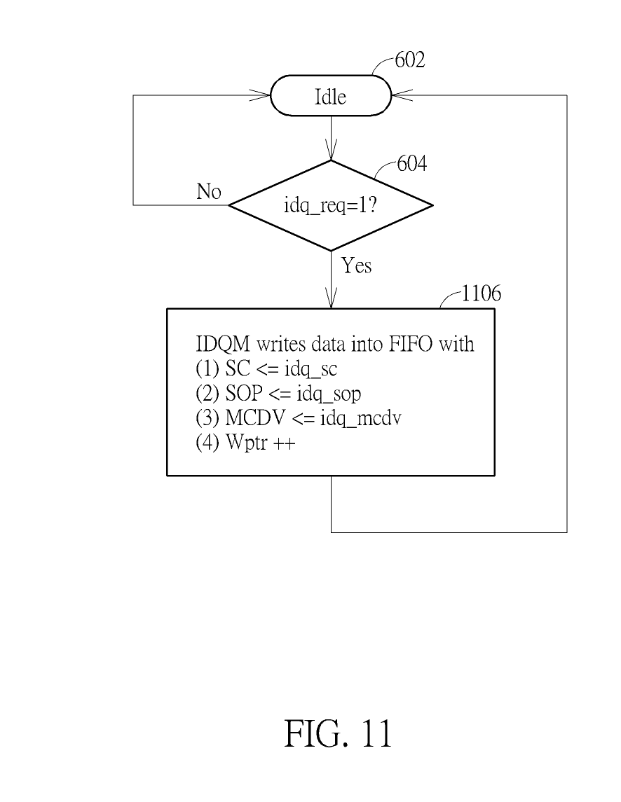

With regard to the IDQM circuit 110 in FIG. 10, the packet enqueue flow in FIG. 6 is modified due to the modified FIFO structure employed by the ingress drop queue 118. FIG. 11 is a flowchart illustrating another packet enqueue flow of an ingress packet decided to be dropped for at least one egress port designated by the ingress packet according to an embodiment of the invention. Provided that the result is substantially the same, the steps are not required to be executed in the exact order shown in FIG. 11. In addition, one or more steps may be added to or removed from the packet release flow shown in FIG. 11. The packet enqueue flow is performed by the IDQM circuit 110 in FIG. 10. Compared to the packet enqueue flow in FIG. 6, the packet enqueue flow in FIG. 11 uses step 1106 to take the place step 606. In step 1106, the IDQM circuit 110 enqueues the ingress packet to be dropped into the ingress drop queue (e.g., FIFO buffer) 118 by storing the associated packet information into an entry pointed to by the FIFO write pointer Wptr, where the packet information (SC, SOP, MCDV) is set by (idq_sc, idq_sop, idq_mcdv). After the ingress packet to be dropped is enqueued, the IDQM circuit 110 increases the FIFO write pointer Wptr to point to a next entry of the ingress drop queue (e.g., FIFO buffer) 118.

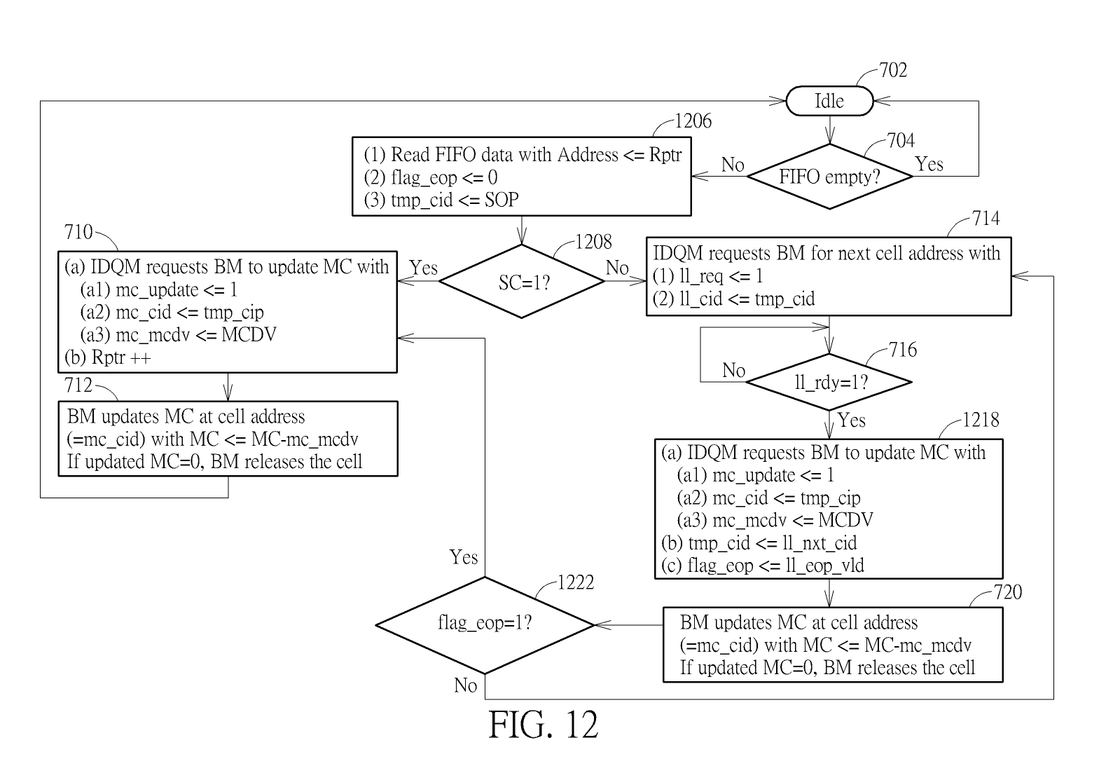

With regard to the IDQM circuit 110 and the BM circuit 108 in FIG. 10, the packet release flow in FIG. 7 is modified due to the modified linked list structure employed by the linked list memory 117 and the modified FIFO structure employed by the ingress drop queue 118. FIG. 12 is a flowchart illustrating another packet release flow of an ingress packet decided to be dropped for at least one egress port designated by the ingress packet according to an embodiment of the invention. Provided that the result is substantially the same, the steps are not required to be executed in the exact order shown in FIG. 12. In addition, one or more steps may be added to or removed from the packet release flow shown in FIG. 12. The packet release flow is performed by the IDQM circuit 110 and the BM circuit 108 in FIG. 10. Compared to the packet release flow in FIG. 7, the packet release flow in FIG. 12 uses steps 1206, 1208, 1218 and 1222 to take the place of steps 706, 708, 718 and 722, respectively.

In step 1206, the IDQM circuit 110 reads packet information recorded in an entry pointed to by the FIFO read pointer Rptr, sets a variable flag eop by an initial value, e.g., 0, and sets another variable tmp_cid by an initial value (e.g., an SOP cell address read from the entry pointed to by the FIFO read pointer Rptr). The variable flag_eop indicates if the next cell is an EOP cell.

In step 1208, the IDQM circuit 110 checks if the SC value read from the entry pointed to by the FIFO read pointer Rptr is equal to one. If SC=1, it indicates that the packet length of the ingress packet to be dropped is equal to or smaller than a one-cell size. Hence, there is no need to traverse a linked list of such a single-cell packet. The packet release flow proceeds with step 710. However, if SC≠1, it indicates that the packet length of the ingress packet to be dropped is larger than a one-cell size. Hence, a linked list of such a multi-cell packet should be traversed to find every next cell address. The packet release flow therefore proceeds with step 714.

In step 1218, the IDQM circuit 110 asserts the signal mc_update, sets the signal mc_cid by the variable tmp_cid, and sets the signal mc_mcdv by the MCDV value obtained in step 1206. After the signals mc_update, mc_cid, mc_mcdv are generated from the IDQM circuit 110 to the BM circuit 108, the IDQM circuit 110 updates the variable tmp_cid by the next cell address indicated by the signal ll_nxt_cid given from the BM circuit 108, and updates the variable flag_eop by the signal ll_eop_vld given from the BM circuit 108.

In step 1222, the IDQM circuit 110 checks if the variable flag_eop is equal to one. If flag_eop=1, it means that the next cell is the last cell of the ingress packet to be dropped. Hence, there is no need to get the next cell address from the BM circuit 108, and the packet release flow proceeds with step 710. Steps 710 and 712 are executed to release the last cell of the ingress packet to be dropped. However, if flag_eop≠1, it means that the next cell is not the last cell of the ingress packet to be dropped. Hence, the next cell address needs to be obtained from the BM circuit 108, and the packet release flow proceeds with step 714. The steps 714, 716, 1218 and 720 are executed to release the current cell of the ingress packet to be dropped.

In above embodiments, the packet enqueue flow and the packet release flow are performed by the packet processing apparatus 100 with the BM circuit 108 employing the cell-based MC enqueue and dequeue method. However, this is for illustrative purposes only, and is not meant to be a limitation of the invention. The same concept of using the IDQM circuit 110 to facilitate cell release of an ingress packet decided to be dropped for at least one egress port designated by the ingress packet can be applied to the packet processing apparatus 100 with the BM circuit 108 employing the packet-based MC enqueue and dequeue method. For example, the packet enqueue flow shown in FIG. 6/FIG. 11 can be used, while the packet release flow shown in FIG. 7/FIG. 12 should be modified to apply one MC value reduction to only one MC value stored in a single cell address, i.e., SOP cell address, if the ingress packet to be dropped is a single-cell packet, and apply one MC value reduction to only one MC value stored in one of a plurality of cell addresses if the ingress packet to be dropped is a multi-cell packet. The same objective of using an IDQM circuit to quickly release used cells of an ingress packet enqueued in an ingress drop queue to a BM circuit is achieved. This also falls within the scope of the invention.

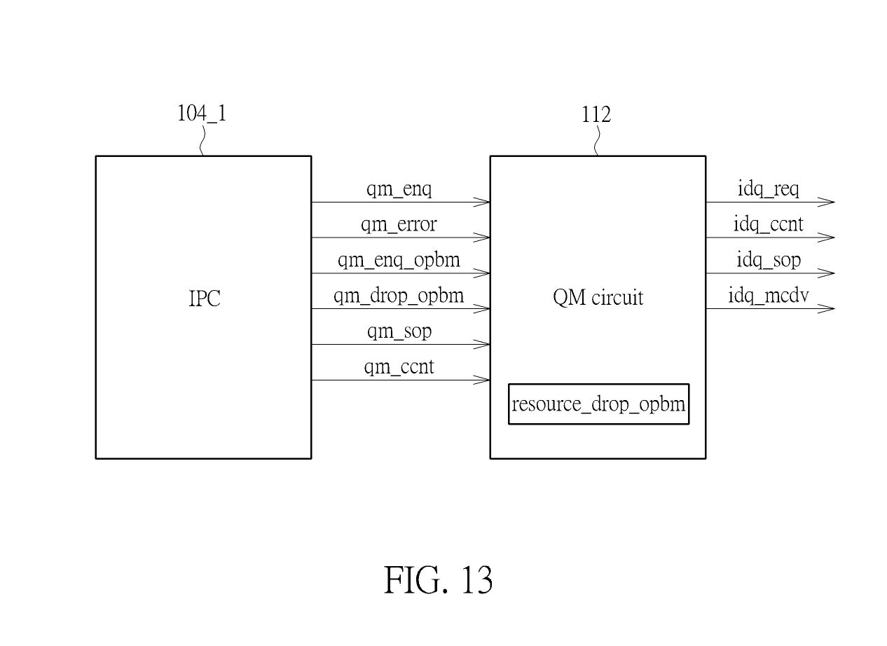

The QM circuit 112 shown in FIG. 5/FIG. 10 generates signals idq_ccnt, idq_sop, idq_mcdv for enqueuing an ingress packet into the IDQM circuit 110 according to information given from one of the IPCs 104_1-104_N that receives the ingress packet decided to be dropped for at least one egress port designated by the ingress packet. FIG. 13 is a diagram illustrating a configuration of an interface between one IPC (e.g., 104_1) and the QM circuit 112 according to an embodiment of the invention. It should be noted that the same interface configuration shown in FIG. 13 can be applied to the interface between the QM circuit 112 and any of the IPCs 104_1-104_N. For clarity and simplicity, only the interface between the IPC 104_1 and the QM circuit 112 is shown in FIG. 13 and is detailed as below.

The IPC 104_1 generates signals qm_enq, qm_error, qm_enq_opbm, qm_drop_opbm, qm_sop, qm_ccnt to the QM circuit 112. The signal qm_enq is a request for enqueuing an ingress packet received by the IPC 104_1 into the QM circuit 112. The signal qm_sop carries the SOP cell address of the ingress packet to be enqueued. The signal qm_ccnt indicates the used cell count of the ingress packet to be enqueued.

The signal qm_enq_opbm carries a one-hot expression variable that identifies the output port bitmap of the ingress packet. For example, if the ingress packet will be forwarded via egress ports TX0, TX1, TX4, qm_enq_opbm will be 0xb1_0011. In other words, the signal qm_enq_opbm is also indicative of the number of egress ports that are allowed to forward the ingress packet. The signal qm_drop_opbm carries a one-hot express variable that identifies the MOP truncation port bitmap. The one-hot express variable qm_drop_opbm may be regarded as the difference between an SOP forwarding result from the PF circuit 102 and the one-hot express variable qm_enq_opbm. For example, after the SOP cell of the ingress packet is received, the forwarding result initially decides that the output port bitmap is 0xb1_1111. However, after some cells following the SOP cell are received, forwarding the ingress packet to some egress ports need to be blocked because of resource limitation. For example, the ingress packet is dropped for egress ports TX2 and TX3. After the EOP cell of the ingress packet is received, the QM circuit 112 enqueues the ingress packet into selected egress queues of the QM circuit 112 according to qm_enq_opbm=0xb1_0011, and the QM circuit 112 enqueues the ingress packet into the ingress drop queue 118 of the IDQM circuit 110 according to qm_drop_opbm=0xb0_1100.

The signal qm_error indicates if the ingress packet is an error packet. For example, when the ingress packet has a CRC (cyclic redundancy check) error, a packet length error, etc., the ingress packet is regarded as an error packet that needs to be dropped for all egress ports designated by the error packet. For example, when the ingress packet is an error packet and a forwarding result initially decides that the output port bitmap is 0xb1_1111, the IPC 104_1 configures signals qm_enq_opbm and qm_drop_opbm by qm_enq_opbm=0xb0_0000 and qm_drop_opbm=0xb1_1111. After the EOP cell of the ingress packet is received, the ingress packet is not enqueued into any egress queue of the QM circuit 112 due to qm_enq_opbm=0xb0_0000, and the QM circuit 112 enqueues the ingress packet into the ingress drop queue 118 of the IDQM circuit 110 due to qm_drop_opbm=0xb1_1111.

In a first case where the ingress packet received by the IPC 104_1 is an error packet, the IPC 104_1 sends qm_enq=1 and qm_error=1 to the QM circuit 112. In addition, the QM circuit 112 refers to other signals qm_enq_opbm, qm_drop_opbm, qm_sop, qm_ccnt received from the IPC 104_1 to set the signals idq_req, idq_ccnt, idq_sop, idq_mcdv for enqueuing the ingress packet (which is an error packet) into the ingress drop queue 118 of the IDQM circuit 110. For example, signals idq_req, idq_ccnt, idq_sop, idq_mcdv can be set as below:

idq_req = 1
idq_ccnt = qm_ccnt
idq_sop = qm_sop
idq_mcdv = qm_drop_opbm[N]+ qm_drop_opbm[N-1]+...+
qm_drop_opbm[2]+
qm_drop_opbm[1],

where qm_drop_opbm has N bits qm_drop_opbm [N]-qm_drop_opbm [1] corresponding to N egress ports TXN-TX1, respectively. The MCDV value indicates the number of egress ports designated by the ingress packet but not allowed to forward the ingress packet. In this case, the number of egress ports designated by the ingress packet but not allowed to forward the ingress packet is set due to the ingress packet identified as an error packet.

Accounting methodology is a skill to handle the received packet with different priority from the ingress view or egress view. According to the received SOP cell, the FP circuit 102 decides the output port bitmap. When a cell-based MC enqueue and dequeue method is employed by the BM circuit 108, an IPC will write the MC value into the BM circuit 108 for every cell occupied by the received packet. The written MC value is calculated by the output port bitmap of the SOP decision. After receiving some cells of the packet, the FP circuit 102 may decide to drop one or more output ports based on the accounting methodology. After the EOP cell is received, the IPC will collect all un-dropped output port information in the qm_enq_opbm and dropped output port information in the qm_drop_opbm. In a second case where the ingress packet received by the IPC 104_1 is not an error packet but is decided to be dropped for at least one egress port designated by the ingress packet because of MOP truncation, the IPC 104_1 sends qm_enq=1 and qm_error=0 to the QM circuit 112 for enqueuing the ingress packet to selected egress queues of the QM circuit 112 that correspond to un-dropped egress ports specified by qm_enq_opbm. In addition, the QM circuit 112 refers to other signals qm_enq_opbm, qm_drop_opbm, qm_sop, qm_ccnt received from the IPC 104_1 to set the signals idq_req, idq_ccnt, idq_sop, idq_mcdv for enqueuing the ingress packet into the ingress drop queue 118 of the IDQM circuit 110. For example, signals idq_req, idq_ccnt, idq_sop, idq_mcdv can be set as below:

idq_req = 1
idq_ccnt = qm_ccnt
idq_sop = qm_sop
idq_mcdv = qm_drop_opbm[N]+ qm_drop_opbm[N-1]+...+
qm_drop_opbm[2]+
qm_drop_opbm[1],

where qm_drop_opbm has N bits qm_drop_opbm [N]-qm_drop_opbm [1] corresponding to N egress ports TXN-TX1, respectively. The MCDV value indicates the number of egress ports designated by the ingress packet but not allowed to forward the ingress packet. In this case, the number of egress ports designated by the ingress packet but not allowed to forward the ingress packet is set due to an MOP truncation of the ingress packet.

The egress queues 119_1-119_N in the QM circuit 112 may have a limited storage size. Hence, it is possible that the MC reduction is caused by a resource shortage of the QM circuit 112. Supposing that the packet buffer 106 is segmented into M cells, each ingress packet is a single-cell packet, and each cell address recorded in the linked list and the egress queues has q bits. For simplicity, it is assumed M=2̂q. If the QM circuit 112 supports a full size of the packet buffer, each egress queue in the QM circuit 112 needs q*M bits for storing the enqueued packet information when all packets in the packet buffer 106 are enqueued into the same egress queue. If the number of egress ports is P. The QM circuit 112 therefore requires S=q*M*P bits to implement the egress queues. If the egress port count P is high, the size S is large. Most of the QM designs will shrink the size S to a reasonable value, meaning that a received packet maybe dropped for one or more designated egress ports because of queue resource limitation. Taking the exemplary egress queue design in FIG. 3 for example, if each egress queue is allowed to enqueue three packets only, the fourth packet with an associated SOP cell address SOP₃ and the fifth packet with an associated SOP cell address SOP₄ cannot be enqueued into the egress queue 119_1 and should be dropped for the egress port TX1 due to queue resource limitation.

In one exemplary design, the QM circuit 112 further sets a variable resource_drop_opbm when an ingress packet is enqueued by one IPC. In a third case where the ingress packet received by the IPC 104_1 is not an error packet but is decided to be dropped for at least one egress port designated by the ingress packet because of queue resource shortage, the IPC 104_1 sends qm_enq=1 and qm_error=0 to the QM circuit 112 for enqueuing the ingress packet to selected egress queues of the QM circuit 112 that correspond to un-dropped egress ports specified by (qm_enq_opbm-resource_drop_opbm). In addition, the QM circuit 112 refers to other signals qm_enq_opbm, qm_sop, qm_ccnt received from the IPC 104_1 and the variable resource_drop_opbm maintained by the QM circuit 112 to set the signals idq_req, idq_ccnt, idq_sop, idq_mcdv for enqueuing the ingress packet into the ingress drop queue 118 of the IDQM circuit 110. For example, signals idq_req, idq_ccnt, idq_sop, idq_mcdv can be set as below:

idq_req = 1
idq_ccnt = qm_ccnt
idq_sop = qm_sop
idq_mcdv = resource_drop_opbm[N]+ resource_drop_opbm[N-1]+...+
resource_drop_opbm[2]+ resource_drop_opbm[1],

where resource_drop_opbm has N bits resource_drop_opbm[N]-resource drop opbm[1] corresponding to N egress ports TXN-TX1, respectively. The MCDV value indicates the number of egress ports designated by the ingress packet but not allowed to forward the ingress packet. In this case, the number of egress ports designated by the ingress packet but not allowed to forward the ingress packet is set due to a queue resource shortage of the QM circuit 112.

In a fourth case where the ingress packet received by the IPC 104_1 is not an error packet but is decided to be dropped for at least one egress port designated by the ingress packet because of MOP truncation and queue resource shortage, the IPC 104_1 sends qm_enq=1 and qm_error=0 to the QM circuit 112 for enqueuing the ingress packet to selected egress queues of the QM circuit 112 that correspond to un-dropped egress ports specified by (qm_enq_opbm-resource_drop_opbm). In addition, the QM circuit 112 refers to other signals qm_enq_opbm, qm_drop_opbm, qm_sop, qm_ccnt received from the IPC 104_1 and the variable resource_drop_opbm maintained by the QM circuit 112 to set the signals idq_req, idq_ccnt, idq_sop, idq_mcdv for enqueuing the ingress packet into the ingress drop queue 118 of the IDQM circuit 110. For example, signals idq_req, idq_ccnt, idq_sop, idq_mcdv can be set as below:

idq_req = 1
idq_ccnt = qm_ccnt
idq_sop = qm_sop
idq_mcdv = qm_drop_opbm[N]+ qm_drop_opbm[N-1]+...+
qm_drop_opbm[2]+

| | | |
|---|---|---|
| qm_drop_opbm[1] | + | resource_drop_opbm[N]+ |

| | |
|---|---|
| resource_drop_opbm[N-1]+...+ | resource_drop_opbm[2]+ |

resource_drop_opbm[1],

where qm_drop_opbm has N bits qm__drop_opbm[N]-qm_drop_opbm[1] corresponding to N egress ports TXN-TX1, respectively, and resource_drop_opbm has N bits resource_drop_opbm[N]-resource_drop_opbm[1] corresponding to N egress ports TXN-TX1, respectively. The MCDV value indicates the number of egress ports designated by the ingress packet but not allowed to forward the ingress packet. In this case, the number of egress ports designated by the ingress packet but not allowed to forward the ingress packet is set due to an MOP truncation of the ingress packet and a queue resource shortage of the QM circuit.

The invention can use the redundant bandwidth of linked list access in the BM circuit 108 to achieve cell release with 100% line rate. Most of the time, the cell size is larger than the Ethernet minimum packet size (e.g., 64 bytes). For an N-cell packet, the BM circuit 108 may do a linked list operation (N-1) times. Hence, the linked list operation for one packet does not require 100% bandwidth utilization. The BM circuit 108 can have extra or idle bandwidth to deal with the packet release requested by the IDQM circuit 110. Suppose that the link cell size=N bytes, the system clock rate=S MHz, and the network port bandwidth=P Gbps. The linked list bandwidth requirement for one egress port is R MHz, where R=P*1000/(N*8). For example, if the system clock rate S≧2R, the extra bandwidth can be provided to the IDQM circuit 110 to release packet cells with line rate. However, this is for illustrative purposes only, and is not meant to be a limitation of the invention.

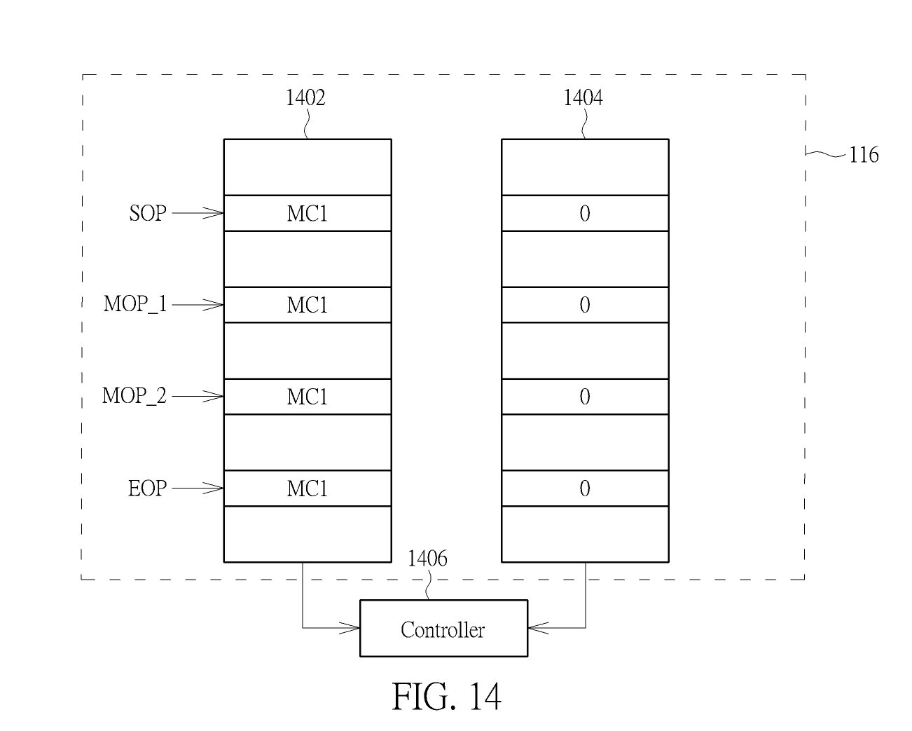

With regard to the MC memory 116, an IPC enqueue operation needs one “write” operation, the EPC dequeue operation needs a “read+write” operation, and the IDQM release operation needs a “read+write” operation. The bandwidth requirement for the MC memory 116 is high. The invention therefore proposes a dual-memory design of the MC memory 116. FIG. 14 is a diagram illustrating an MC enqueue operation applied to an MC memory implemented using multiple memory devices according to an embodiment of the invention. The MC memory 116 has a first MC memory device 1402 and a second MC memory device 1404. In addition to the MC memory 116, the BM circuit 108 may have a controller 1406 to manage the MC memory 116 and other functional blocks of the BM circuit 108. For example, the controller 1406 is arranged to compare values stored in the first MC memory device 1402 and the second MC memory device 1404 to control the cell release procedure of a received packet.

The first MC memory device 1402 is used to store MC values, and the second MC memory device 1404 is used to store MCDV values. When the IPCs 104_1-104_N enqueues MC values into the BM circuit 108, the BM circuit 108 writes the MC values into the first MC memory device 1402, and writes 0's into the MC memory device 1404 at the same cell addresses. When a cell-based MC enqueue and dequeue method is employed by the MC memory 116, the same initial MC value is stored into every cell locations associated with the stored ingress packets. As illustrated in FIG. 14, one packet is segmented into 4 cells, and the same initial MC value MC1 is stored in each of cell addresses SOP, MOP_1, MOP_2 and EOP of the first MC memory device 1402. In addition, one zero value is stored in each of the same cell addresses SOP, MOP_1, MOP_2 and EOP of the second MC memory device 1404. When a packet-based MC enqueue and dequeue method is employed, the initial MC value is stored into one of cell locations associated with the stored ingress packet. For example, the initial MC value is stored in one of cell addresses SOP, MOP_1, MOP_2 and EOP, depending upon actual design consideration.

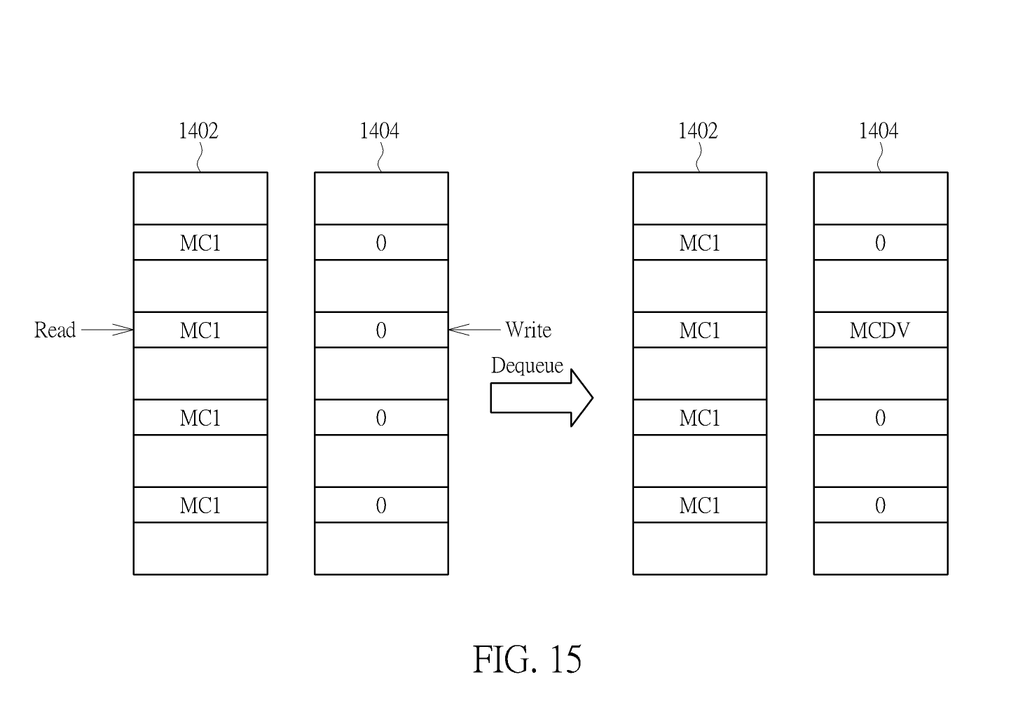

After the MC enqueue operation for an packet is done, the MC dequeue operation may encounter three conditions for cell release of the packet. FIG. 15 is a diagram illustrating a first MC dequeue operation applied to an MC memory implemented using multiple memory devices according to an embodiment of the invention. In this case, the cell is dequeued by the IDQM circuit 110. In a first stage of the MC dequeue, the BM circuit 108 reads the first MC memory device 1402 to get the MC value MC1 stored in the cell address of the dequeued cell, and writes the MCDV value into the second MC memory device 1404 to overwrite the zero value stored in the cell address of the dequeued cell. In a second stage of the MC dequeue, the controller 1406 of the BM circuit 108 checks if the MC value MC1 is equal to the MCDV value. When the MC value MC1 is equal to the MCDV value, the BM circuit 108 releases this cell.

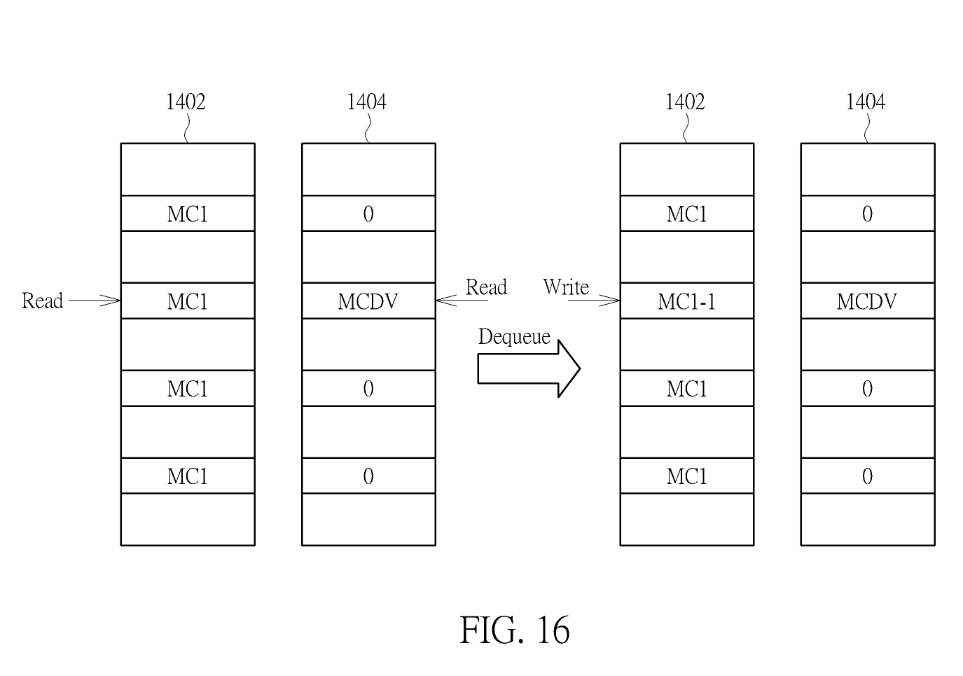

FIG. 16 is a diagram illustrating a second MC dequeue operation applied to an MC memory implemented using multiple memory devices according to an embodiment of the invention. In this case, the cell is dequeued by one of the EPC 114_1-114_N. In a first stage of the MC dequeue, the BM circuit 108 reads the first MC memory device 1402 to get the MC value MC1 stored in the cell address of the dequeued cell, and reads the second MC memory device 1404 to get a value stored in the cell address of the dequeued cell. If the dequeued cell needs to be released by the IDQM circuit 110, the value read from the second MC memory device is the MCDV value. However, if the dequeued cell does not need to be released by the IDQM circuit 110, the value read from the second MC memory device is the zero value. In a second stage of the MC dequeue, the controller 1406 of the BM circuit 108 writes an updated MC value (MC1−1) into the first MC memory device 1402 to overwrite the MC value MC1 stored in the cell address of the dequeued cell, and checks if the updated MC value (MC1−1) is equal to the value (e.g., MCDV value or zero value) read from the second MC memory device 1404. When the MC value (MC1−1) is equal to the value (e.g., MCDV value or zero value) read from the second MC memory device 1404, the BM circuit 108 releases this cell.

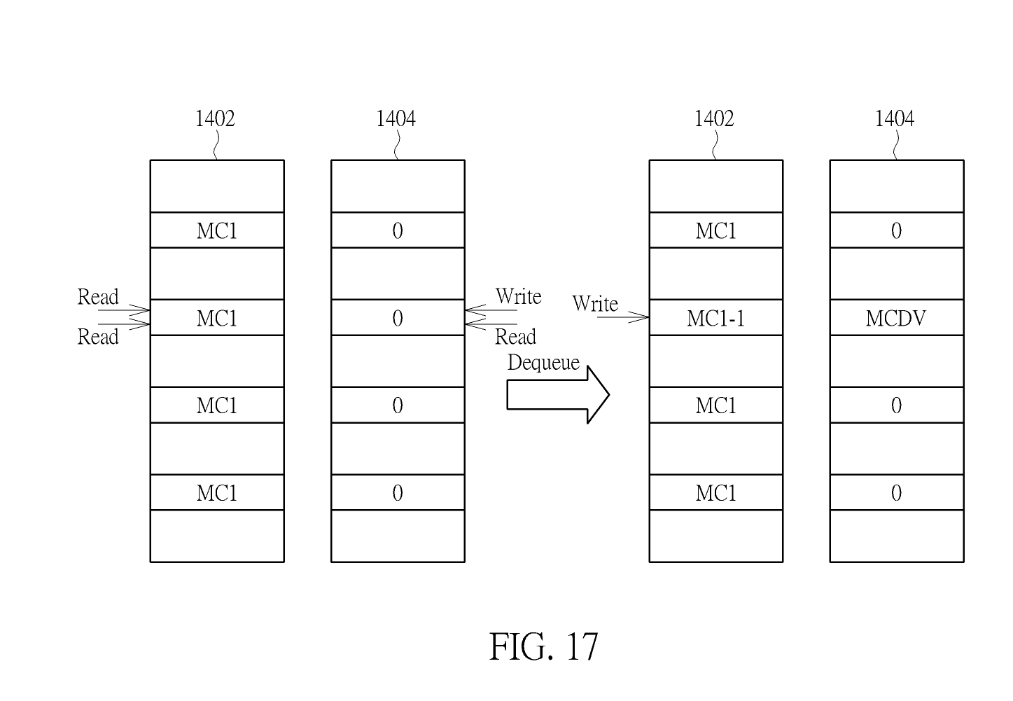

FIG. 17 is a diagram illustrating a third MC dequeue operation applied to an MC memory implemented using multiple memory devices according to an embodiment of the invention. In this case, the cell is dequeued by the IDQM circuit 110 and one of the EPC 114_1-114_N. In a first stage of the MC dequeue, the BM circuit 108 reads the first MC memory device 1402 to get the MC value MC1 stored in the cell address of the dequeued cell and writes the MCDV value into the second MC memory 1404 to overwrite the zero value stored in the cell address of the dequeued cell in response to the IDQM request, and reads the first MC memory device 1402 to get the MC value MC1 stored in the cell address of the dequeued cell and reads the second MC memory device 1404 to get a value stored in the cell address of the dequeued cell in response to the EPC request. In a second stage of the MC dequeue, the controller 1406 of the BM circuit 108 writes an updated MC value (MC1−1) into the first MC memory device 1402 to overwrite the MC value MC1 stored in the cell address of the dequeued cell. In addition, the BM circuit 108 detects that there are two requests for releasing the same cell simultaneously. In one exemplary design, the BM circuit 108 checks if the updated MC value (MC1−1) is equal to the MCDV value. When the MC value (MC1−1) is equal to the MCDV value, the BM circuit 108 releases this cell.

In conclusion, when the MC memory 116 is implemented using a single memory device, the BM circuit 108 serves an IDQM request by directly subtracting the MCDV value from the MC value in response to the IDQM request and then comparing an updated MC value with a threshold value, e.g., 0, to control cell release of an ingress packet to be dropped. In addition, each of the EPCs 114_1-114_N dequeues a packet from a corresponding egress queue in the QM circuit 112, gets the packet data of the dequeued packet from the packet buffer 106, transmits the dequeued packet via a corresponding egress port, and issues one EPC request to the BM circuit 108 for MC reduction. The BM circuit 108 serves the EPC request by reading the MC value from the MC memory, modifying the MC value (e.g., subtracting one from the MC value, that is, MC=MC−1), and writing an updated MC value into the MC memory. An MCDV-based MC reduction (e.g., MC=MC−MCDV) is performed in response to one IDQM request. A one-by-one MC reduction (e.g., MC=MC−1) is performed in response to one EPC request. It should be noted that an ingress packet may be dropped for at least a portion (e.g., part or all) of the egress ports designated by the ingress packet because of packet error, MOP truncation and/or queue resource shortage. Hence, the cell release procedure of the ingress packet to be dropped may be based totally on the IDQM circuit 110 (which sets an MCDV value and triggers MCDV-based MC reduction), or may be based partly on the IDQM circuit 110 (which sets an MCDV value and triggers MCDV-based MC reduction) and partly on the EPCs 114_1-114_N (which trigger one-by-one MC reduction). In a case where a cell-based MC enqueue and dequeue method is employed by the BM circuit, one used cell of a packet decided to be dropped is released when an associated MC value becomes a zero value. In another case where a packet-based MC enqueue and dequeue method is employed by the BM circuit, all used cells of a packet decided to be dropped are released when one MC value stored at one particular cell address (e.g., SOP cell address) becomes a zero value.

When the MC memory 116 is implemented using two memory devices, the BM circuit 108 serves an IDQM request by storing the MCDV value into the second MC memory device and comparing the MC value stored in the first MC memory device with a threshold value (e.g., MCDV value stored in the second MC memory device) to control cell release of an ingress packet to be dropped. In addition, each of the EPCs 114_1-114_N dequeues a packet from a corresponding egress queue in the QM circuit 112, gets the packet data of the dequeued packet from the packet buffer 106, transmits the dequeued packet via a corresponding egress port, and issues one EPC request to the BM circuit 108 for MC reduction. The BM circuit 108 serves the EPC request by reading the MC value from the first MC memory device, modifying the MC value (e.g., subtracting one from the MC value, that is, MC=MC−1), and writing an updated MC value into the first MC memory device. A one-by-one MC reduction (e.g., MC=MC−1) is performed in response to one EPC request. Concerning the IDQM request, it requests a write operation for writing an MCDV value into the second MC memory device without changing the MC value stored in the first MC memory device. Hence, compared to an MC memory using the single-memory design, an MC memory using the dual-memory design has a reduced memory bandwidth requirement for MC reduction. It should be noted that an ingress packet may be dropped for at least a portion (e.g., part or all) of the egress ports designated by the ingress packet because of packet error, MOP truncation and/or queue resource shortage. Hence, the cell release procedure of the ingress packet to be dropped may be based totally on the IDQM circuit 110 (which sets and writes an MCDV value), or may be based partly on the IDQM circuit 110 (which sets and writes an MCDV value) and partly on the EPCs 114_1-114_N (which trigger one-by-one MC reduction). In a case where a cell-based MC enqueue and dequeue method is employed by the BM circuit, one used cell of a packet decided to be dropped is released when an associated MC value is equal to an MCDV value. In another case where a packet-based MC enqueue and dequeue method is employed by the BM circuit, all used cells of a packet decided to be dropped are released when one MC value stored at one particular cell address (e.g., SOP cell address) is equal to an MCDV value.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet processing apparatus comprising:
a buffer manager (BM) circuit, arranged to maintain at least one multicast counter (MC) value for an ingress packet;
an ingress drop queue manager (IDQM) circuit; and
a queue manager (QM) circuit, arranged to maintain a plurality of egress queues for a plurality of egress ports, respectively;
wherein when the ingress packet is decided to be dropped for at least one egress port designated by the ingress packet, the QM circuit is arranged to enqueue the ingress packet into the IDQM circuit without enqueuing the ingress packet into at least one egress queue of the at least one egress port, and the IDQM circuit is arranged to refer to the ingress packet enqueued therein to request the BM circuit to perform cell release of the ingress packet.

2. The packet processing apparatus of claim 1, wherein the QM circuit is arranged to enqueue the ingress packet into the IDQM circuit by sending packet information of the ingress packet to the IDQM circuit, and the packet information comprises a start of packet (SOP) cell address.

3. The packet processing apparatus of claim 2, wherein the IDQM circuit is arranged to instruct the BM circuit to locate the at least one MC value according to at least the SOP cell address.

4. The packet processing apparatus of claim 1, wherein the QM circuit is arranged to enqueue the ingress packet into the IDQM circuit by sending packet information of the ingress packet to the IDQM circuit, and the packet information comprises a used cell count of the ingress packet.

5. The packet processing apparatus of claim 4, wherein the IDQM circuit is arranged to control a procedure of the cell release of the ingress packet according to at least the used cell count.

6. The packet processing apparatus of claim 5, wherein the IDQM circuit is further arranged to maintain a released cell count of the ingress packet; and when the used cell count is larger than one, the IDQM circuit is arranged to control the procedure of the cell release of the ingress packet according to a result of comparing the used cell count with the released cell count.

7. The packet processing apparatus of claim 1, wherein the QM circuit is arranged to enqueue the ingress packet into the IDQM circuit by sending packet information of the ingress packet to the IDQM circuit, and the packet information comprises a single cell packet flag which indicates whether a packet length of the ingress packet is not larger than a one-cell size.

8. The packet processing apparatus of claim 7, wherein the IDQM circuit is arranged to control a procedure of the cell release of the ingress packet according to at least the single cell packet flag.

9. The packet processing apparatus of claim 8, wherein the BM circuit is further arranged to maintain a linked list of the ingress packet; at least one node of the linked list includes an address of a next cell of the ingress packet and an end of packet (EOP) flag which indicates whether the next cell is an EOP cell; and when the single cell packet flag indicates that the packet length of the ingress packet is larger than the one-cell size, the IDQM circuit is arranged to control the procedure of the cell release of the ingress packet according to a result of checking if the EOP flag indicates that the next cell is the EOP cell.

10. The packet processing apparatus of claim 1, wherein the QM circuit is arranged to enqueue the ingress packet into the IDQM circuit by sending packet information of the ingress packet to the IDQM circuit, and the packet information comprises an MC decrement value which indicates a number of egress ports designated by the ingress packet but not allowed to forward the ingress packet.

11. The packet processing apparatus of claim 10, wherein the number of egress ports designated by the ingress packet but not allowed to forward the ingress packet is set due to the ingress packet identified as an error packet.

12. The packet processing apparatus of claim 10, wherein the number of egress ports designated by the ingress packet but not allowed to forward the ingress packet is set due to a middle of packet (MOP) truncation of the ingress packet.

13. The packet processing apparatus of claim 10, wherein the number of egress ports designated by the ingress packet but not allowed to forward the ingress packet is set due to a queue resource shortage of the QM circuit.

14. The packet processing apparatus of claim 10, wherein the number of egress ports designated by the ingress packet but not allowed to forward the ingress packet is set due to a middle of packet (MOP) truncation of the ingress packet and a queue resource shortage of the QM circuit.

15. The packet processing apparatus of claim 10, wherein the IDQM circuit is arranged to instruct the BM circuit to perform the cell release of the ingress packet by subtracting the MC decrement value from the at least one MC value.

16. The packet processing apparatus of claim 10, wherein the BM circuit comprises:
a first MC memory device, arranged to store the at least one MC value for the ingress packet; and
a second MC memory device;
wherein the IDQM circuit is arranged to store the MC decrement value in the second MC memory device, and the BM circuit controls the cell release of the ingress packet by comparing the at least one MC value in the first MC memory device with the MC decrement value in the second MC memory device.

17. A packet processing method comprising:
maintaining at least one multicast counter (MC) value for an ingress packet;
maintaining a plurality of egress queues for a plurality of egress ports, respectively;
when the ingress packet is decided to be dropped for at least one egress port designated by the ingress packet, not enqueuing the ingress packet into at least one egress queue of the at least one egress port, and enqueuing the ingress packet into an ingress drop queue; and
referring to information of the ingress packet enqueued in the ingress drop queue to control cell release of the ingress packet.

18. A packet processing apparatus comprising:
a buffer manager (BM) circuit, comprising:
a first multicast counter (MC) memory device, arranged to store at least one MC value for a received packet;
a second MC memory device, arranged to store at least one cell release threshold value for the received packet; and
a controller, arranged to compare the at least one MC value in the first MC memory device with the at least one cell release threshold value in the second MC memory device to control cell release of the received packet.

19. The packet processing apparatus of claim 18, wherein the at least one cell release threshold value is set by a number of egress ports designated by the received packet but not allowed to forward the received packet due to the received packet identified as an error packet.

20. The packet processing apparatus of claim 18, wherein the at least one cell release threshold value is set by a number of egress ports designated by the received packet but not allowed to forward the received packet due to a middle of packet (MOP) truncation of the received packet.

21. The packet processing apparatus of claim 18, wherein the at least one cell release threshold value is set by a number of egress ports designated by the received packet but not allowed to forward the received packet due to a queue resource shortage of the QM circuit.

22. The packet processing apparatus of claim 18, wherein the at least one cell release threshold value is set by a number of egress ports designated by the received packet but not allowed to forward the received packet due to a middle of packet (MOP) truncation of the received packet and a queue resource shortage of the QM circuit.
